(19) United States
(12) Patent Application Publication
(10) Pub. No.: US 2014/0295022 A1
(43) Pub. Date: Oct. 2, 2014

(54) PRALINES-IN-A-JAR

(71) Applicant: SABINA A. MILLER, Thibodaux, LA (US)

(72) Inventor: SABINA A. MILLER, Thibodaux, LA (US)

(73) Assignee: Martine Gabrielle Giammancheri, Thibodaux, LA (US)

(21) Appl. No.: 13/733,888

(22) Filed: Mar. 27, 2013

(51) Int. Cl. A23G 3/48; A23L 1/36

(52) U.S. Cl. CPC A23G 3/48; A23L 1/364
USPC 426/2; 426/632

(57) ABSTRACT

My invention, Pralines-In-A-Jar, is a fully-cooked praline candy mixture that is preserved in a jar or plastic bag.

My invention, Pralines-In-A-Jar, is a fully-cooked praline candy mixture that is preserved in a jar or plastic bag.

The initial purpose of Pralines-In-A-Jar is to make fresh pralines by warming the jar or bag in the microwave for 2 to 3 minutes and then spooning the liquefied mixture onto waxed paper. After 2 minutes the consumer has fresh pecan pralines.

The shelf-life of my product is 3 to 6 months when kept in the refrigerator after initial use.

The secondary purpose of Pralines-In-A-Jar is to revolutionize the manner in which pralines are made. This perfected product will save time for restaurant owners and will save money for the average consumer.

I, Sabina A. Miller, claim:

1. A formulation for preserving pecan praline candy, comprising: a. natural pecans; b. white sugar; and c. brown sugar; d. light syrup; e. evaporated milk; f. sea salt; g. white chocolate; g. dark chocolate; h. natural butter; and i. Rum, wherein the formulation for making pralines is substantially free of water and synthetic preservatives.

2. A process for making praline candy, comprising: a. providing a mixture comprising butter, evaporated milk and sea salt; and b. white sugar and brown sugar in equal parts and then adding light corn syrup; wherein the first admixture and second mixture are substantially free of synthetic preservatives.

3. The process of the end user to make fresh pralines in 5 minutes includes; a. removing the lid from the glass or plastic jar; b. placing the glass or plastic jar or the plastic bag in the microwave on high for 2 to 3 minutes; c. allowing the praline formula to liquefy; d. removing jar or bag from microwave; e. stirring to balance liquid; f. spooning out liquid onto waxed paper; g. waiting 3 minutes for candy to dry; h. eat candy.
